(19) United States
(12) Patent Application Publication
(10) Pub. No.: US 2025/0221868 A1
(43) Pub. Date: Jul. 10, 2025

(54) VEHICLE-MOUNTED SECURING DEVICE FOR SECURING OBJECT LOADED INTO VEHICLE

(71) Applicants: Hyundai Motor Company, Seoul (KR); Kia Corporation, Seoul (KR); Yong San Co., Ltd., Ulsan (KR)

(72) Inventors: JIN HO HWANG, Cheonan-si (KR); Ji Seob PARK, Yeonsu-gu (KR); Sang Heon LEE, Seoul (KR); Kyung Jae PARK, Asan-si (KR); Choon Taik KIM, Yongin-si (KR)

(73) Assignees: Hyundai Motor Company, Seoul (KR); Kia Corporation, Seoul (KR); Yong Dan Co., Ltd., Ulsan (KR)

(21) Appl. No.: 18/817,061

(22) Filed: Aug. 27, 2024

(30) Foreign Application Priority Data
Jan. 10, 2024 (KR) 10-2024-0004210

(51) Int. Cl. A61G 3/08; B60R 11/00

(52) U.S. Cl. CPC A61G 3/0808; B60R 11/00; B60R 2011/007

(57) ABSTRACT

In a vehicle-mounted securing device for securing an object loaded into a vehicle, the vehicle-mounted securing device includes a fixing module provided on the object that needs to be secured when the object is loaded into the vehicle, and a magnetic module provided in the vehicle, configured to mechanically secure the object including the fixing module as a portion of the fixing module is inserted into the magnetic module, and configured to magnetically secure the object including the fixing module by a magnetic element provided inside the magnetic module.

### CROSS-REFERENCE TO RELATED APPLICATION

The present application claims priority of Korean Patent Application No. 10-2024-0004210 filed on Jan. 10, 2024, the entire contents of which is incorporated herein for all purposes by this reference.

### BACKGROUND OF THE PRESENT DISCLOSURE

### Field of the Present Disclosure

The present disclosure relates to a vehicle-mounted securing device for securing an object loaded into a vehicle, and more particularly, to a vehicle-mounted securing device for securing a wheelchair or the like loaded into a vehicle.

### Description of Related Art

A device for securing a wheelchair for a disabled person may be provided in a vehicle to ensure safety of the disabled person. Furthermore, components for a vehicle, such as a console device capable of controlling some functions of the vehicle, may be detachably provided in the vehicle.

There is an increasing need for a vehicle-mounted securing device capable of easily attaching or detaching an object, such as the wheelchair or the console device, which is loaded into the vehicle, and providing an excellent securing force in the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle-mounted securing device configured for easily attaching or detaching an object loaded into a vehicle and providing an excellent securing force.

According to one aspect, there is provided a vehicle-mounted securing device for securing an object loaded into a vehicle, the vehicle-mounted securing device including: a fixing module provided on the object that needs to be secured when the object is loaded into the vehicle; and a magnetic module provided in the vehicle, configured to mechanically secure the object including the fixing module as a part of the fixing module is inserted into the magnetic module, and configured to magnetically secure the object including the fixing module by a magnetic element provided inside the magnetic module.

The fixing module may be provided at a lower end portion of the object that needs to be secured, and the magnetic module may be provided on an upper surface of a floor of the vehicle.

The magnetic module may include a fixing holder including a guide groove formed therein, the fixing module may include a fixing guide configured to guide an insertion direction along the guide groove formed in the fixing holder, and the fixing guide may be inserted into the fixing holder so that the object including the fixing module may be mechanically secured.

One end portion of the fixing holder, at which the insertion of the fixing guide is started, may include a ‘V’ shape, and an area of an inlet may decrease inward so that the insertion direction of the fixing guide may be guided.

One end portion of the fixing holder, at which the insertion of the fixing guide is started, may include an inclined surface, and one end portion of the fixing guide may be inserted into the fixing holder while moving downward by sliding along the inclined surface, securing the object loaded into the vehicle.

The fixing module may further include a fixing bracket provided on the object, which needs to be secured, and configured to connect the fixing guide and the object that needs to be secured.

The fixing bracket and the fixing guide may be connected to each other by a guide bolt including an external peripheral surface on which an elastic member is provided, and the guide bolt may be configured to be movable in an upward or downward (upward/downward) direction in the fixing guide.

A pair of magnetic elements may be provided inside the magnetic module, a first magnetic element may be provided so that directions of magnetic poles are fixed, and a second magnetic element may be provided so that directions of magnetic poles are changeable so that when the fixing module is inserted and the directions of the magnetic poles of the second magnetic element are changed, the fixing module is selectively magnetically-fixed.

The first magnetic element may include a rod shape, the second magnetic element may include a shape of a circle, and a coil may be provided between the first magnetic element and the second magnetic element so that when power is applied to the coil, the directions of the magnetic poles of the second magnetic element may be changed.

The first magnetic element may include a rod shape, the second magnetic element may include a shape of a circle, and the second magnetic element may be connected to an electric motor so that the directions of the magnetic poles of the second magnetic element may be changed by operation of the electric motor.

The magnetic module may include: a lower plate provided inside a floor of the vehicle; and a housing including the magnetic element therein, coupled to the lower plate, and configured to define an external wall of the magnetic module.

The lower plate and the housing may be connected to each other by a guide pin including an external peripheral surface on which an elastic member is provided, and the guide pin may be configured to be movable in a leftward or rightward (leftward/rightward) direction in the lower plate.

A height adjustment portion may be provided at a lateral side of the lower plate to move the lower plate in an upward and downward direction thereof.

The height adjustment portion may include: a step motor provided at the lateral side of the lower plate; and a lead screw connected to the step motor, and a height of the lower plate may be adjusted by operation of the step motor.

A first sensor may be provided on an upper surface of the floor of the vehicle and configured for measuring a distance from a lower surface of the fixing module, and the vehicle-mounted securing device may further include a controller configured to control operation of the step motor based on a detecting value of the first sensor.

The magnetic module may include a fixing holder including a guide groove formed therein, the fixing module may include a fixing guide configured to guide an insertion direction along the guide groove formed in the fixing holder, a second sensor may be provided on the fixing holder and measure a distance from the fixing guide, and the vehicle-mounted securing device may further include a controller configured to determine whether the fixing guide is completely inserted into the fixing holder based on a detecting value of the second sensor and control the transmission of a signal sound.

The magnetic module may include: a housing including the magnetic element therein and configured to define an external wall of the magnetic module; and an upper plate covering an upper surface of the housing.

A fixing holder, which includes a guide groove formed therein, may be attached to or detached from an upper surface of the upper plate.

A coupling hole may be formed in the upper surface of the upper plate so that the fixing holder is attached to or detached from the coupling hole or a portion of the fixing module, which is provided on the object that needs to be secured, may be inserted into the coupling hole so that the object, which needs to be secured, may be mechanically secured to an upper portion of the upper plate.

A plurality of power connector holes and a plurality of signal connector holes may be formed in the upper surface of the upper plate, and the fixing module may have power connectors inserted into the plurality of power connector holes, and signal connectors inserted into the plurality of signal connector holes so that the power connectors and the signal connectors may be electrically connected.

The vehicle-mounted securing device for securing an object loaded into a vehicle of the present disclosure may easily attach or detach the object loaded into a vehicle and provide an excellent securing force.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a vehicle-mounted securing device according to an exemplary embodiment of the present disclosure, FIG. 2 is a cross-sectional view taken along line A-A in FIG. 1, and FIG. 3 is a cross-sectional view taken along line B-B in FIG. 1.

FIG. 4 is a view exemplarily illustrating a state in which a pair of fixing modules provided on a wheelchair are inserted into magnetic modules provided on a floor of a vehicle so that the wheelchair is secured in the vehicle.

FIG. 5 is a view exemplarily illustrating a state in which a fixing guide is coupled to a fixing holder.

FIG. 6 is a view exemplarily illustrating a state in which the fixing guide is coupled to the fixing holder.

FIG. 7 is a perspective view of the vehicle-mounted securing device including a height adjustment portion.

FIG. 8 is a view exemplarily illustrating the magnetic module from which the fixing holder is detached.

FIG. 9 is a view exemplarily illustrating a state in which a console device is coupled to the magnetic module.

FIG. 10 is a view for explaining electrical connection between an upper plate and the fixing module.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION OF THE PRESENT DISCLOSURE

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. The same or similar constituent elements are assigned with the same reference numerals regardless of reference numerals, and the repetitive description thereof will be omitted.

In the description of the exemplary embodiments included in the present specification, the specific descriptions of publicly known related technologies will be omitted when it is determined that the predetermined descriptions may obscure the subject matter of the exemplary embodiments included in the present specification. Furthermore, it should be interpreted that the accompanying drawings are provided only to allow those skilled in the art to easily understand the exemplary embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably to facilitate the description, but the suffixes themselves do not have distinguishable meanings or functions.

When one constituent element is described as being “coupled” or “connected” to another constituent element, it should be understood that one constituent element may be coupled or directly connected to another constituent element, and an intervening constituent element can also be present between the constituent elements. When one constituent element is described as being “directly coupled to” or “directly connected to” another constituent element, it should be understood that no intervening constituent element is present between the constituent elements.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

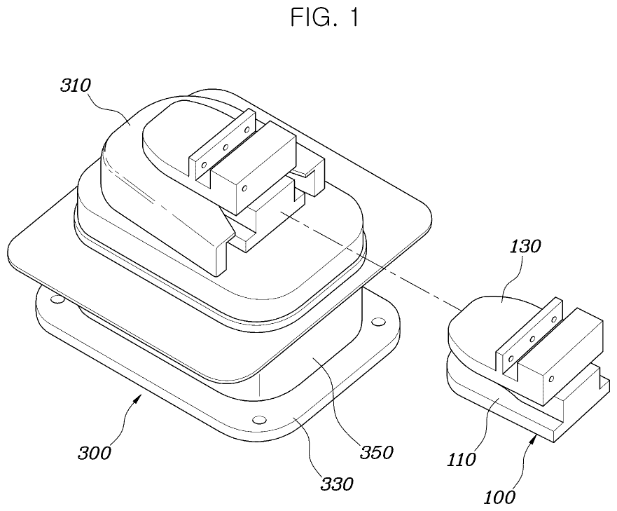

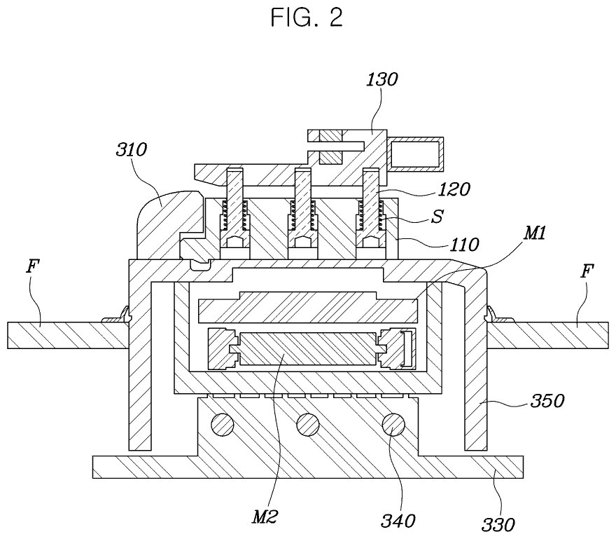

FIG. 1 is a view exemplarily illustrating a vehicle-mounted securing device according to an exemplary embodiment of the present disclosure, FIG. 2 is a cross-sectional view taken along line A-A in FIG. 1, and FIG. 3 is a cross-sectional view taken along line B-B in FIG. 1.

With reference to FIG. 1, FIG. 2, and FIG. 3, fixing modules 100 are provided on an object to be loaded into a vehicle. The object may be an object that needs to be secured in the vehicle to ensure safety among objects to be loaded into the vehicle. For example, the object may be a wheelchair in which a disabled person is seated.

Assuming that the object, which needs to be secured, is a wheelchair in which a disabled person is seated, the present disclosure will be described.

Magnetic modules 300 are provided in the vehicle. The fixing module 100 provided on the wheelchair is partially inserted into the magnetic module 300 so that the wheelchair including the fixing module 100 is mechanically secured. Furthermore, a magnetic element M may be provided inside the magnetic module 300 and mechanically and magnetically fix the fixing module so that the wheelchair may be secured in the vehicle.

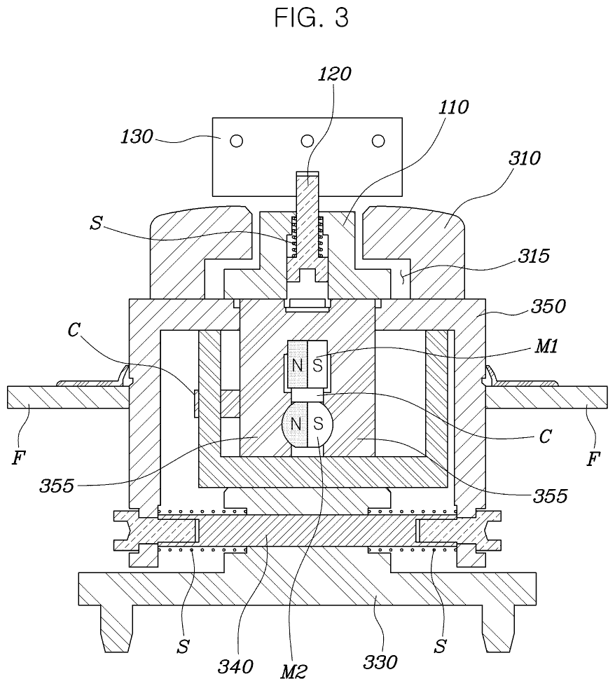

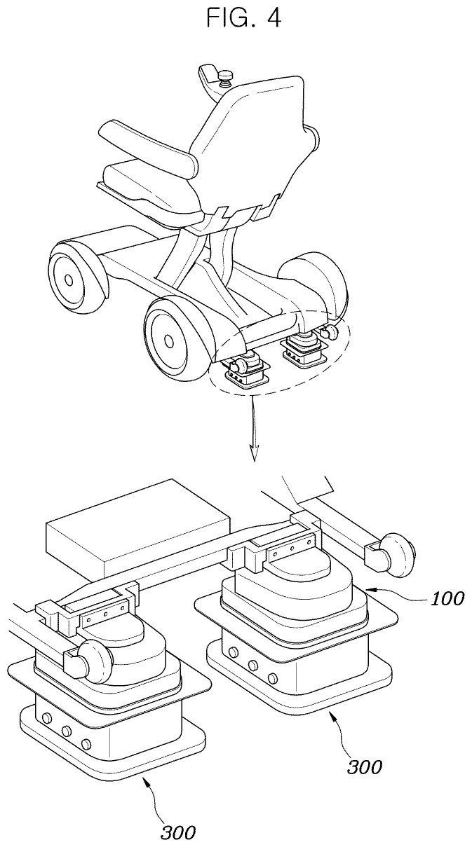

FIG. 4 is a view exemplarily illustrating a state in which the pair of fixing modules 100 provided on the wheelchair are inserted into the magnetic modules 300 provided on a floor of the vehicle so that the wheelchair is secured in the vehicle.

Meanwhile, the fixing module 100 may be provided on any portion of the object that needs to be secured. However, the fixing module 100 may be provided at a lower end portion of the object in consideration of a center of gravity of the object and a distance from a ground surface.

Furthermore, the magnetic module 300 may also be provided at any location in the vehicle. However, the magnetic module 300 may be provided on an upper surface of the floor.

Meanwhile, the magnetic module 300 includes a fixing holder 310 configured to mechanically fix the fixing module 100. A guide groove 315 is formed in the fixing holder 310 and guides a direction in which the fixing module 100 is inserted.

The fixing module 100 includes a fixing guide 110 configured to be inserted into the fixing holder 310. When the fixing guide 110 is completely inserted into the fixing holder 310 along the guide groove 315 formed in the fixing holder 310, the fixing holder 310 restricts a movement of the fixing guide 110.

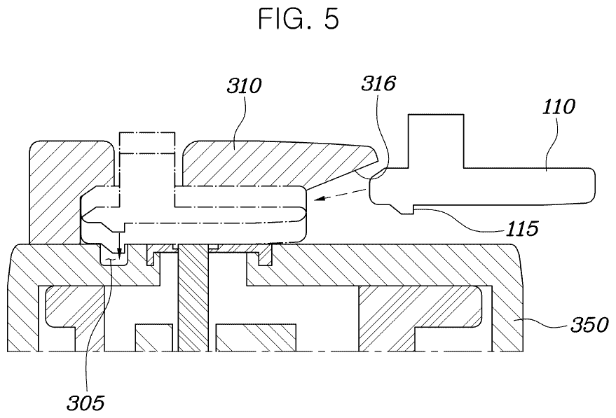

FIG. 5 is a view exemplarily illustrating a state in which the fixing guide is coupled to the fixing holder. FIG. 6 is a view exemplarily illustrating a state in which the fixing guide is coupled to the fixing holder.

A shape of the fixing holder 310 will be specifically described with reference to FIG. 5 and FIG. 6. One end portion of the fixing holder 310, at which the insertion of the fixing guide 110 is started, includes a ‘V’ shape, and an area of an inlet of the fixing holder 310 decreases inwardly. Therefore, the insertion direction of the fixing guide 110 may be guided by the shape of one end portion of the fixing holder 310 when the fixing guide 110 is inserted into the fixing holder 310. The position of the fixing guide 110 may be fixed as the fixing guide 110 passes through the large inlet of the fixing holder 310 first and then passes through a point at which the inlet gradually decreases so that the movement of the fixing guide 110 may be restricted.

Furthermore, an inclined surface 316 may be formed at one end portion of the fixing holder 310 at which the insertion of the fixing guide 110 is started. The fixing guide 110 may be inserted into the fixing holder 310 while moving downward by sliding along the inclined surface 316 formed on the fixing holder 310. A protruding portion 115 may be formed at an end portion of the fixing guide 110 and protrude downward, and a stepped portion 305 recessed inward may be formed in the magnetic module. When the fixing guide 110 is completely inserted into the fixing holder 310, the protruding portion 115 may be coupled by being caught by the stepped portion 305 so that the fixing guide 110 may be completely inserted into the fixing holder 310.

Meanwhile, the fixing module 100 may further include a fixing bracket 130 provided on the object, which needs to be secured, and configured to connect the fixing guide 110 to the object that needs to be secured. The fixing bracket 130 is configured as an intermediate connection body between the fixing guide 110 and the object. The fixing bracket 130 needs to be strongly coupled to the object to prevent the fixing bracket 130 from separating from the object.

Guide bolts 120 may be provided between the fixing bracket 130 and the fixing guide 110, and the guide bolts 120 may connect the fixing bracket 130 and the fixing guide 110. An elastic member S may be provided on an external peripheral surface of the guide bolt 120, and the elastic member S adjoins the fixing guide 110 so that the guide bolt 120 may move in an upward and downward direction in the fixing guide 110.

The guide bolts 120 may be provided as a plurality of guide bolts 120 provided between the fixing guide 110 and the fixing bracket 130.

Therefore, even though tolerance is partially present between the fixing guide 110 and the fixing holder 310 when the fixing guide 110 is inserted into the fixing holder 310, the fixing guide 110 may be coupled to the fixing holder 310 while the guide bolt 120 may absorb the tolerance while moving.

Furthermore, the elastic member S may be contracted or extended by upward/downward vibration, flexibly coping with the upward/downward vibration.

The fixing holder 310 provided on the magnetic module 300 may mechanically fix the fixing module 100, and the magnetic element M provided inside the magnetic module 300 may magnetically fix the fixing module 100.

With reference to FIG. 3, a pair of magnetic elements may be provided inside the magnetic module. A first magnetic element M1 may be provided so that directions of poles thereof are fixed, and a second magnetic element M2 may be provided so that directions of poles thereof are changeable. Therefore, when the directions of the magnetic poles of the second magnetic element M2 are changed while the fixing module 100 is inserted, the fixing module 100 may be magnetically fixed to the magnetic module 300 or released from the magnetic module 300.

That is, as illustrated in FIG. 3, when the second magnetic element M2 rotates so that the pole of the second magnetic element M2 and the pole of the first magnetic element M1 are directed in the same direction, a magnetic force for pulling the fixing module 100 toward the magnetic module 300 is generated as magnetic flux passes through the fixing guide 110 of the fixing module 100 so that the fixing module 100 may be magnetically coupled to the magnetic module 300.

On the other hand, to detach the fixing module 100, when the second magnetic element M2 rotates so that the pole of the second magnetic element M2 and the pole of the first magnetic element M1 are directed in opposite directions, magnetic flux defines routes only in the magnetic module 300 without passing through the fixing module 100 so that the fixing module 100 is magnetically uncoupled from the magnetic module 300.

Meanwhile, the first magnetic element M1 may include a rod shape, and the second magnetic element M2 may include a shape of a circle. A coil C may be provided between the first magnetic element M1 and the second magnetic element M2, and the directions of the magnetic poles of the second magnetic element M2 may be changed when direction of power applied to the coil C is changed. That is, when power is applied to the coil C, the coil C is configured as an electromagnet and rotate the second magnetic element M2 according to the polarity of the current applied to the coil C.

Alternatively, the second magnetic element M2 is not connected to the coil, but the second magnetic element M2 may be connected to an electric motor for rotating the second magnetic element M2 so that the directions of the magnetic poles of the second magnetic element M2 may be changed by operation of the electric motor. That is, when power is applied to the electric motor, the second magnetic element M2 may be rotated by a rotation force of the electric motor so that the directions of the magnetic poles of the second magnetic element M2 may be changed. The second magnetic element M2 may be directly coupled to the electric motor. Furthermore, a reduction gear may be additionally provided between the electric motor and the second magnetic element M2 to transmit the rotation force of the electric motor to the second magnetic element M2.

Meanwhile, the magnetic module 300 may include a lower plate 330 provided inside a floor F of the vehicle, and a housing 350 including the magnetic element M therein, coupled to the lower plate 330, and configured to define an external wall of the magnetic module 300.

A pair of pole panels 355 may be provided inside the housing 350 and configured to define movement routes for magnetic flux. The first magnetic element M1 may be provided inside the pole panels 355 so that the directions of the magnetic poles thereof are fixed, and the second magnetic element M2 may be provided inside the pole panels 355 so that the directions of the magnetic poles thereof are changeable according to the rotation of second magnetic element M2.

In the instant case, the coil C or the electric motor may be accommodated in the housing 350 to rotate the second magnetic element M2.

Meanwhile, the lower plate 330 and the housing 350 may be connected to each other by a guide pin 340 including an external peripheral surface on which an elastic member S is provided, and the guide pin 340 is configured to be movable in the lower plate 330 in a leftward and rightward direction thereof.

With reference to FIG. 2 and FIG. 3, the guide pin 340 may penetrate the lower plate 330 and the housing 350 in a width direction of the lower plate 330 and connect the lower plate 330 and the housing. The elastic members S are provided on an external peripheral surface of the guide pin 340, and the elastic members S are simultaneously in contact with the lower plate 330 and the housing 350 so that the guide pin 340 may move in the leftward/rightward direction thereof.

The guide pin 340 may be provided as a plurality of guide pins 340 provided in the width direction of the lower plate 330.

The guide pin 340 may be provided to absorb tolerance of the fixing module 100 and the magnetic module 300 which may occur in the width direction of the lower plate 330. The elastic members S, which are provided on the external peripheral surface of the guide pin 340, may be contracted or expanded by vibration in the width direction, flexibly coping with the vibration in the width direction thereof.

Meanwhile, various types of objects may need to be secured to the vehicle, and a height at which the fixing module 100 is provided may vary depending on the types of objects. Even when the objects are of the same type, the objects may be different in heights at which the fixing modules 100 are provided. For example, even when the wheelchairs are of the same type, the wheelchairs may be manufactured by different manufacturers, and the wheelchairs may be different in positions at which the fixing modules 100 are provided.

Therefore, a height adjustment portion 400 may be provided on a lateral side of the lower plate 330 and configured to adjust a height of the magnetic module 300 by moving the lower plate 330 in the upward and downward direction thereof.

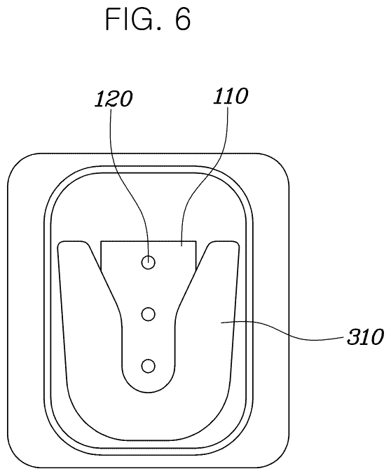

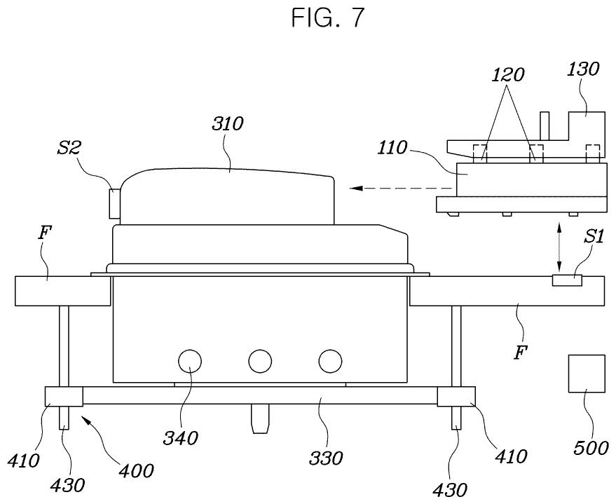

With reference to FIG. 7, the height adjustment portion 400 may include step motors 410 provided at the lateral side of the lower plate 330, and lead screws 430 connected to the step motors 410 and the floor F. Therefore, a height of the lower plate 330 may be adjusted by operation of the step motor 410. The step motor 410 may be provided at a lateral side of an edge point of the lower plate 330, and the lead screw 430 may be provided at a position partially spaced from the lower plate 330 so that the lower plate 330 may be connected to the lead screw 430 through the step motor 410.

Therefore, when the step motor 410 is operated by power applied to the step motor 410, the lower plate 330 may move upward or downward.

Meanwhile, a first sensor S1 may be provided on the upper surface of the floor F of the vehicle and measure a distance from a lower surface of the fixing module 100. A controller 500 may be further provided to control the operation of the step motor 410 based on a detecting value of the first sensor S1.

The first sensor S1 may measure the distance from the lower surface of the fixing module 100 provided on the object. The controller 500 may be further provided to move the lower plate 330 upward or downward by controlling the operation of the step motor 410 so that the fixing guide 110 of the fixing module 100 may be inserted into the fixing holder 310.

In case that the lower plate 330 is completely moved upward or downward to an appropriate height, the controller 500 may be configured for controlling an operation of generating a signal sound indicating that the fixing guide 110 may be inserted into the fixing holder 310.

Furthermore, a second sensor S2 may be provided on the fixing holder 310 and measure a distance from the fixing guide 110. The controller 500 may be configured to determine whether the fixing guide 110 is completely inserted based on a detecting value of the second sensor S2 and control an operation of generating a signal sound indicating that the fixing guide 110 is completely inserted.

Sensor S1 and S2 may be common sensors used not only for ultrasonic sensor but also for measuring distances between objects.

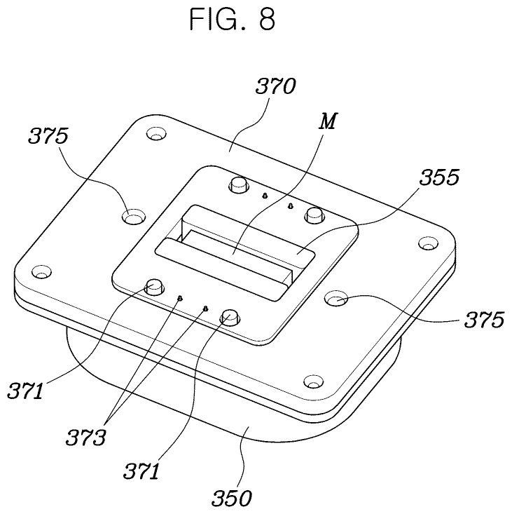

Meanwhile, FIG. 8 is a view exemplarily illustrating the magnetic module from which the fixing holder is detached. With reference to FIG. 8, the magnetic module 300 may include the housing 350 including the magnetic element M therein and configured to define an external wall of the magnetic module 300, and an upper plate 370 configured to cover an upper surface of the housing 350.

The fixing holder 310 may be detachably provided on the upper surface of the upper plate 370 and include the guide groove 315 formed therein. Coupling holes 375 may be formed in the upper surface of the upper plate 370, and the fixing holder 310 may be attached or detached by the coupling holes 375.

That is, as long as the object may be secured to the vehicle by use of the fixing holder 310, the fixing holder 310 may be attached to the upper plate 370, and then the object may be secured to the vehicle.

In contrast, in some instances, in case that an object, which does not require the fixing holder 310, is directed to be secured to the vehicle, a part of the fixing module 100 provided on the object, which needs to be secured, may be inserted into the coupling hole 375 so that the object, which needs to be secured, may be mechanically secured to an upper portion of the upper plate 370.

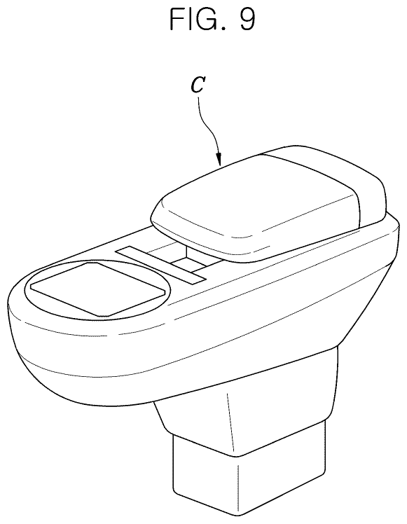

For example, the object, which does not require the fixing holder 310, may be a console device C configured for controlling some functions of the vehicle. With reference to FIG. 9, a fixing module may be provided on the console device C, and the console device may be fixed to the upper plate of the magnetic module by the fixing module. In the instant case, the fixing module may be magnetically coupled to the magnetic module by the magnetic element provided inside the magnetic module.

Meanwhile, the console device C needs to be electrically connected to the vehicle to control some functions of the vehicle. Therefore, a plurality of power connector holes 371 and a plurality of signal connector holes 373 may be formed in the upper surface of the upper plate 370. The fixing module 100 may have power connectors 176 inserted into the plurality of power connector holes 371, and signal connectors 178 inserted into the plurality of signal connector holes 373 so that the upper plate 370 and the fixing module 100 may be electrically connected.

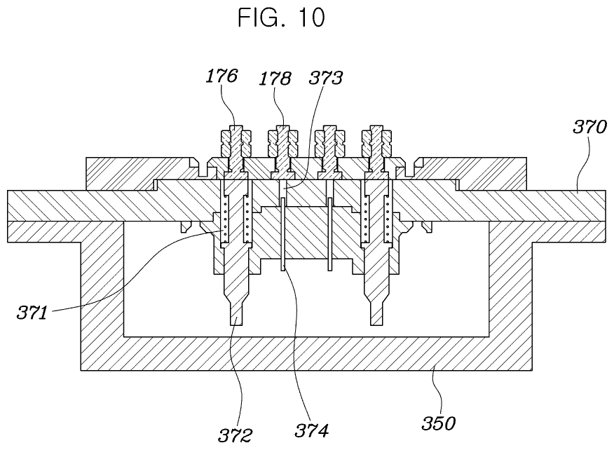

With reference to FIG. 10, a pogo connector may be provided in the power connector hole 371, and a pogo pin is provided in the power connector so that the pogo connector and the pogo pin may be connected by coming into electric contact with each other.

The signal connector hole 373 and the signal connector 178 may also be connected by a pogo connector, a pogo pin or signal pin 374. A female connector may be provided in the signal connector hole, and a male connector may be provided in the signal connector so that the female connector and the male connector may be electrically connected to each other.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

In addition, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code that may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

In various exemplary embodiments of the present disclosure, the control device may be implemented in a form of hardware or software, or may be implemented in a combination of hardware and software.

In addition, the terms such as “unit”, “module”, etc. disclosed in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle-mounted securing apparatus for securing an object loaded into a vehicle, the vehicle-mounted securing device comprising:
a fixing module provided on the object that needs to be secured when the object is loaded into the vehicle; and
a magnetic module provided in the vehicle, configured to mechanically secure the object including the fixing module as a part of the fixing module is inserted into the magnetic module, and configured to magnetically secure the object including the fixing module by a magnetic element provided inside the magnetic module.

2. The vehicle-mounted securing apparatus of claim 1, wherein the fixing module is provided at a lower end portion of the object that needs to be secured, and the magnetic module is provided on an upper surface of a floor of the vehicle.

3. The vehicle-mounted securing apparatus of claim 1,
wherein the magnetic module includes a fixing holder including a guide groove formed therein,
wherein the fixing module includes a fixing guide configured to guide an insertion direction along the guide groove formed in the fixing holder, and
wherein the fixing guide is inserted into the fixing holder so that the object including the fixing module is mechanically secured to the magnetic module.

4. The vehicle-mounted securing apparatus of claim 3, wherein one end portion of the fixing holder, at which the insertion of the fixing guide is started, includes a ‘V’ shape, and an area of an inlet in the fixing holder decreases inward of the fixing holder so that the insertion direction of the fixing guide is guided.

5. The vehicle-mounted securing apparatus of claim 3, wherein one end portion of the fixing holder, at which the insertion of the fixing guide is started, includes an inclined surface, and one end portion of the fixing guide is inserted into the fixing holder while moving downward by sliding along the inclined surface.

6. The vehicle-mounted securing apparatus of claim 3, wherein the fixing module further includes a fixing bracket provided on the object, which needs to be secured, and configured to connect the fixing guide and the object that needs to be secured.

7. The vehicle-mounted securing apparatus of claim 6, wherein the fixing bracket and the fixing guide are connected to each other by a guide bolt including an external peripheral surface on which an elastic member is provided, and the guide bolt is configured to be movable in an upward and downward direction in the fixing guide.

8. The vehicle-mounted securing apparatus of claim 1,
wherein a pair of magnetic elements is provided inside the magnetic module, and
wherein the pair of magnetic elements includes a first magnetic element in which directions of magnetic poles are fixed, and a second magnetic element in which directions of magnetic poles are changeable so that when the fixing module is inserted and the directions of the magnetic poles of the second magnetic element are changed, the fixing module is selectively magnetically-fixed.

9. The vehicle-mounted securing apparatus of claim 8, wherein the first magnetic element includes a rod shape, the second magnetic element includes a shape of a circle, and a coil is provided between the first magnetic element and the second magnetic element so that according to a direction of the power applied to the coil, the directions of the magnetic poles of the second magnetic element are changed.

10. The vehicle-mounted securing apparatus of claim 8, wherein the first magnetic element includes a rod shape, the second magnetic element includes a shape of a circle, and the second magnetic element is connected to an electric motor so that the directions of the magnetic poles of the second magnetic element are changed by operation of the electric motor.

11. The vehicle-mounted securing apparatus of claim 1, wherein the magnetic module includes:
a lower plate provided inside a floor of the vehicle; and
a housing including the magnetic element therein, coupled to the lower plate, and configured to define an external wall of the magnetic module.

12. The vehicle-mounted securing apparatus of claim 11, wherein the lower plate and the housing are connected to each other by a guide pin including an external peripheral surface on which an elastic member is provided, and the guide pin is configured to be movable in a leftward and rightward direction in the lower plate.

13. The vehicle-mounted securing apparatus of claim 11, wherein a height adjustment portion is provided at a lateral side of the lower plate to move the lower plate in an upward and downward direction thereof.

14. The vehicle-mounted securing apparatus of claim 13, wherein the height adjustment portion includes:
a step motor provided at the lateral side of the lower plate; and
a lead screw connected to the step motor and the floor of the vehicle, and
wherein a height of the lower plate is adjusted by operation of the step motor.

15. The vehicle-mounted securing apparatus of claim 14, further including:
a first sensor provided on an upper surface of the floor of the vehicle and configured for measuring a distance from a lower surface of the fixing module; and
a controller configured to control operation of the step motor based on a detecting value of the first sensor.

16. The vehicle-mounted securing apparatus of claim 1,
wherein the magnetic module includes a fixing holder including a guide groove formed therein, the fixing module includes a fixing guide configured to guide an insertion direction along the guide groove formed in the fixing holder, and a second sensor is provided on the fixing holder and configured to measure a distance from the fixing guide, and
wherein the vehicle-mounted securing device further includes a controller configured to determine whether the fixing guide is completely inserted into the fixing holder based on a detecting value of the second sensor and control generation of a signal sound indicating that the fixing guide is completely inserted.

17. The vehicle-mounted securing apparatus of claim 1, wherein the magnetic module includes:
a housing including the magnetic element therein and configured to define an external wall of the magnetic module; and
an upper plate covering an upper surface of the housing.

18. The vehicle-mounted securing apparatus of claim 17, wherein a fixing holder, which includes a guide groove formed therein, is attached to or detached from an upper surface of the upper plate.

19. The vehicle-mounted securing apparatus of claim 18, wherein a coupling hole is formed in the upper surface of the upper plate so that the fixing holder is attached to or detached from the coupling hole or a part of the fixing module, which is provided on the object that needs to be secured, is inserted into the coupling hole so that the object, which needs to be secured, is mechanically secured to an upper portion of the upper plate.

20. The vehicle-mounted securing apparatus of claim 18, wherein a plurality of power connector holes and a plurality of signal connector holes are formed in the upper surface of the upper plate, and the fixing module includes power connectors inserted into the plurality of power connector holes, and signal connectors inserted into the plurality of signal connector holes so that the power connectors and the signal connectors are electrically connected.
